(19) United States
(12) Patent Application Publication
(10) Pub. No.: US 2006/0280241 A1
(43) Pub. Date: Dec. 14, 2006

(54) Uncompressed to compressed digital file converter device for use with compressed digital file storage and playback devices

(76) Inventors: Richard Weston, Beverly Hills, CA (US); Yahya Ahdout, Los Angeles, CA (US)

Correspondence Address: CHRISTIE, PARKER & HALE, LLP, PO BOX 7068, PASADENA, CA, 91109-7068, US

(21) Appl. No.: 11/448,402

(22) Filed: Jun. 6, 2006

Related U.S. Application Data
(60) Provisional application No. 60/688,854, filed on Jun. 8, 2005.

(51) Int. Cl. H04B 1/66

(52) U.S. Cl. 375/240

(57) ABSTRACT

A compressed digital signal converter device. The converter is a device that converts an analog or digital source signal to a compressed digital signal. It preferably includes memory for storing the compressed digital signal for transferring it to a compressed digital file storage device, such as a MP3 or a MPEG-4 storage and playback device.45

### CROSS REFERENCE TO RELATED APPLICATIONS

This application claims priority to provisional patent application No. 60/688,854, filed on Jun. 8, 2005.

### FIELD OF THE INVENTION

The present invention relates to compressed digital file (e.g., MP3 and MP4) signal converters, and more specifically to uncompressed input to compressed digital file output signal converters and methods thereof for use with digital file storage and playback devices.

### BACKGROUND OF THE INVENTION

Compressed digital file (e.g., MP3 (MPEG1, Audio Layer 3), MPEG-4, and H.264) storage and playback devices, such as the Apple® iPod® and iPod® Video are capable of storing a large numbers of MP3 audio and MPEG-4 and H.264 compressed video files and playing these back with excellent sound and video reproduction quality. Some other compressed file types include WMA (Windows Media Audio), a popular net audio format, Vorbis (Ogg Vorbis), an “open-source” digital audio compression format, and WMV (Windows Media Video), a proprietary compression format for motion video.

In the case of music playback device, such MP3 playback devices, these are intended for interactive use with a personal computer, in which specialized MP3 management software enables the selection of an analog or digital audio input source signal; the conversion of such source signal to an MP3 file; the storage of such MP3 file to the computer RAM or hard drive; and the downloading of such computer-stored MP3 file to an MP3 storage and playback device. The complexity and inconvenience of the above-described computer operations, however, often discourage individuals from purchasing and using MP3 storage and playback devices. The same can be said for MPEG-4 and other devices which store compressed digital files.

From a practical standpoint, what is needed is a compressed digital file converter in which an analog or digital audio input source signal is directly converted to a compressed digital signal (e.g., MP3 or MPEG-4) without requiring an intervening personal computer, providing digital MP3, MPEG-4 and other file(s) that may optionally be stored in internal memory and which are downloaded to an MP3 or MPEG-4, or other compressed digital file storage and playback devices.

### SUMMARY OF THE INVENTION

The present invention is a compressed digital file signal converter, in which an analog or digital audio input source signal is directly converted to MP3, MPEG-4, or other compressed digital files, without requiring an intervening personal computer, providing corresponding digital MP3 or MPEG-4 and other compressed digital file(s) that may be downloaded to an MP3 or MPEG-4 and other compressed digital file storage and playback devices. Ordinarily such MP3 or MPEG-4 and other compressed digital file converters would be inherently limited to real time audio analog input signal downloading to the MP3 or MPEG-4 converter, and also would be limited to real time MP3 or MPEG-4 digital output signal downloading to an MP3 or MPEG-4 storage and playback device. Again, the invention can be used for any compressed digital file types.

In one embodiment, digital memory, such as plugable memory card(s), stores the above-described converted digital file(s) and enables accelerated digital output signal downloading to a compressed digital storage and playback device. Such digital memory, however, does not resolve the limitation of real time audio analog input signal downloading to the compressed digital file converter.

In another embodiment, the compressed digital signal file converter of the preferred embodiment further comprises at least one of (a) a device to mechanically accept and electronically interconnect to an iPod® or similar MP3, MPEG-4 or other compressed digital file storage and playback device, (b) a stereo audio power amplifier, or (c) a stereo audio power amplifier and stereo speakers.

In yet another alternative embodiment the compressed digital signal file converter comprises a CD/DVD player wherein a CD or DVD is at least one of (a) read as non-compressed digital signal, converted to an MP3 signal (or other compressed digital file) and downloaded to an MP3 or other compressed digital file storage and playback device at accelerated rates, or (b) read as a non-compressed digital signal, converted to MP3 or other compressed digital file(s), stored on digital memory and downloaded from the digital memory to a compressed digital file storage and playback device at accelerated rates. Alternatively, the CD/DVD player may optionally operate at real time audio playback rates and provide an audio output signal suitable for amplification and speaker playback, wherein a CD or DVD is at least one of (a) read as a non-compressed digital signal but at real time audio playback rates, converted to an output compressed digital signal, and downloaded to an MP3 or other compressed digital file storage and playback device again at real time audio playback rates, or (b) read as a non-compressed digital signal but at real time audio playback rates, converted to a compressed digital file(s), stored on digital memory, and downloaded from the digital memory to an compressed digital file storage and playback device at accelerated rates.

In a further embodiment, the compressed digital signal converter and CD/DVD player of the second alternative embodiment further comprises at least one of (a) a device to mechanically accept and electronically interconnect to an iPod® or similar MP3 and other compressed digital file storage and playback device, (b) a stereo audio power amplifier, or (c) a stereo audio power amplifier and stereo speakers.

The above and further objects, features and advantages of the present invention will be more fully understood from the following descriptions taken with the drawings, in which designated letters and numbers correspond to all like letters and numbers in the text.

### BRIEF DESCRIPTION OF THE DRAWINGS

FIG. 1 is a drawing of a prior art compressed digital file storage and playback device interactively coupled to a personal computer.

FIG. 2 is a drawing of a first exemplary compressed digital signal converter of the invention.

FIG. 3 is a drawing of another exemplary embodiment of a compressed digital signal converter of the invention.

FIG. 4 is a drawing of the compressed digital signal converter, stereo audio power amplifier and stereo speakers of a further exemplary embodiment of the invention.

FIG. 5 is a drawing of the compressed digital signal converter and CD/DVD player of a further exemplary embodiment of the present invention.

FIG. 6 is a drawing of yet another exemplary embodiment of a compressed digital signal converter, CD/DVD player, stereo audio power amplifier and stereo speakers of the invention.

### DETAILED DESCRIPTION OF THE INVENTION

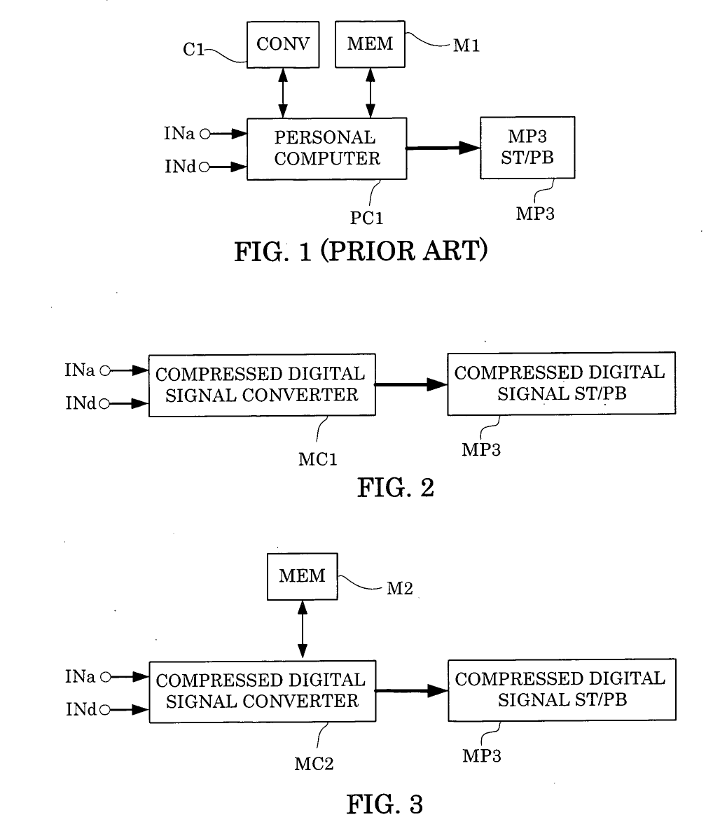

FIG. 1 is a drawing of a prior art compressed digital file storage and playback device (e.g., a MP3 device) interactively coupled to a personal computer PC1, in which analog source signal INa and digital source signal INd are applied as inputs to personal computer PC1 comprising compressed digital file (e.g., MP3) converter C1 and digital memory M1. Converter C1 converts one of input signal INa or INd to compressed digital file(s) that are stored in digital memory M1, processed by PC1 and applied as input to external MP3 storage and compressed digital file playback device MP3.

FIG. 2 is a drawing of a first exemplary compressed digital signal (e.g., MP3) converter of the invention, in which analog source signal INa and digital source signal INd are applied as inputs to compressed digital signal converter MC1. MC1 converts one of input signal INa or INd to a compressed digital file(s) (e.g., MP3) that are processed by MC1 and applied as input to external compressed digital signal storage and playback device MP3.

FIG. 3 is a drawing of a second exemplary compressed digital signal (e.g., MP3) converter of another embodiment of the invention, in which analog source signal INa and digital source signal INd are applied as inputs to compressed digital signal converter MC2. MC2 converts one of input signal INa or INd to MP3 file(s) that are stored in internal digital memory M2, processed by compressed digital signal converter MC2 and applied as input to external compressed digital signal storage and playback device MP3.

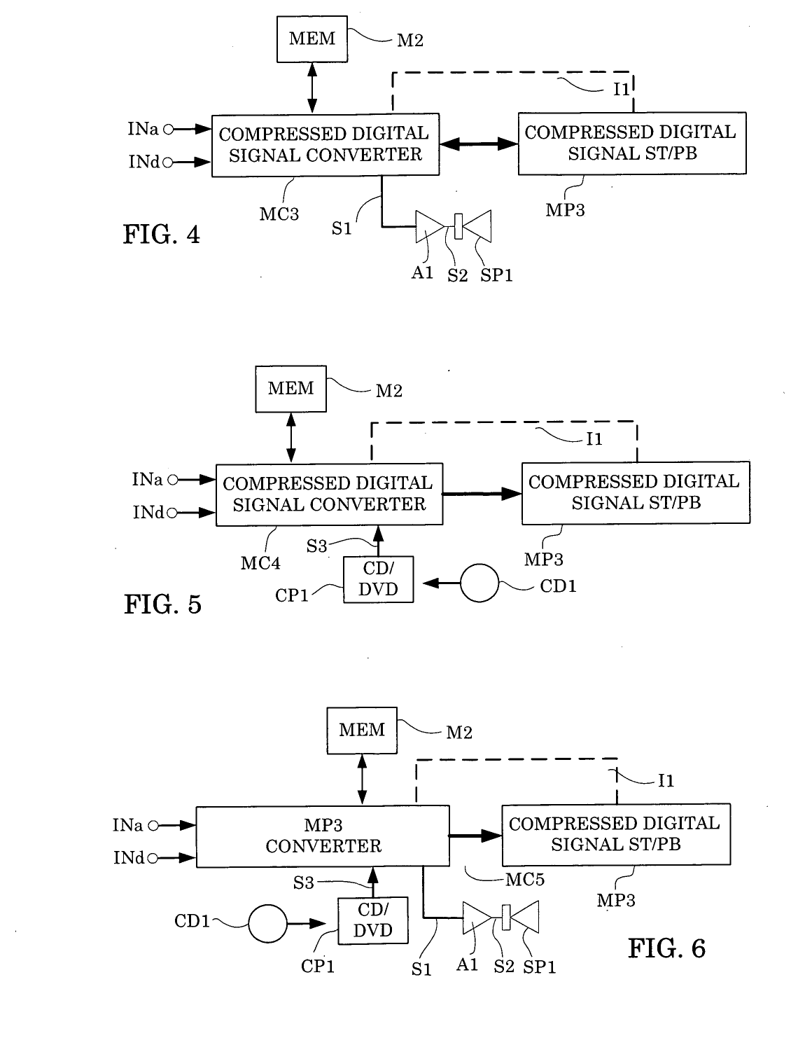

FIG. 4 is a drawing of an exemplary compressed digital signal converter, stereo audio power amplifier and stereo speakers of another exemplary embodiment of the invention, in which analog source signal INa and digital source signal INd are applied as inputs to compressed digital signal converter MC3. Compressed digital signal converter MC3 converts one of input signal INa or INd to MP3 file(s) that are stored in internal digital memory M2, processed by MC3 and applied as input to external compressed digital signal storage and playback device MP3. Compressed digital signal converter MP3 mechanically and electronically interconnects to MC3 by an interconnection I1. MC3 applies analog stereo signal S1 to stereo audio power amplifier A1. Stereo audio power amplifier A1 provides as output amplified stereo signal S2 applied to stereo speakers SP1.

FIG. 5 is a drawing of the compressed digital signal converter MC4 and a CD/DVD player of yet another embodiment of the invention, in which analog source signal INa, digital source signal INd and analog stereo signal S3 from internal CD/DVD player CP1, are applied as inputs to a compressed digital signal converter MC4. MC4 converts one of input signal INa, INd or S3 to compressed digital file(s) that are stored in internal digital memory M2, processed by MC4 and applied as input to external compressed digital file storage and playback device MP3. MP3 mechanically and electronically interconnects to MC4 by interconnection I1.

FIG. 6 is a drawing of a compressed digital signal converter, CD/DVD player, stereo audio power amplifier and stereo speakers of a further exemplary embodiment of the invention, in which analog source signal INa, digital source signal INd and analog stereo signal S3 from internal CD/DVD player CP1, comprising CD/DVD CD1, are applied as inputs to compressed digital signal converter MC5. Compressed digital signal converter MC5 converts one of input signal INa or INd to MP3 file(s) that are stored in internal digital memory M2, processed by compressed digital signal converter MC5 and applied as input to external compressed digital signal storage and playback device MP3. MP3 mechanically and electronically interconnects to external compressed digital file storage and playback device MC5 by interconnection means I1. MC5 applies analog stereo signal S1 to stereo audio power amplifier A1. Stereo audio power amplifier A1 provides as output amplified stereo signal S2 applied to stereo speakers SP1.

Again, as noted above, the invention can be used with any compressed digital signals and files, such as MP3, MPEG-4, or other compressed digital file, without requiring an intervening personal computer, providing corresponding digital MP3 or MPEG-4 and other compressed digital file(s) that may be downloaded to an MP3 or MPEG-4 and other compressed digital file storage and playback devices. Ordinarily such MP3 or MPEG-4 and other compressed digital file converters would be inherently limited to real time audio analog input signal downloading to the MP3 or MPEG-4 converter, and also would be limited to real time MP3 or MPEG-4 digital output signal downloading to an MP3 or MPEG-4 storage and playback device.

Although embodiments of the present invention have been described in detail hereinabove in connection with certain exemplary embodiments, it should be understood that the invention is not limited to the disclosed exemplary embodiments, but, on the contrary is intended to cover various modifications and/or equivalent arrangements included within the spirit and scope of the present invention.

I claim:

1. A compressed digital signal converter, comprising:
a device that converts an analog or digital source signal to a compressed digital signal.

2. The compressed digital signal converter of claim 1, wherein the device comprises memory for storing said compressed digital signal.

3. The compressed digital signal converter of claim 1, further comprising a power amplifier and speakers.

4. The compressed digital signal converter of claim 1, wherein the compressed digital signal converter connects mechanically and electrically to an external compressed digital signal storage and playback device.

5. The compressed digital signal converter of claim 1, wherein the compressed digital signal converter is integral with an uncompressed signal storage and playback device.

6. The compressed digital signal converter of claim 5, wherein the uncompressed signal storage and playback device comprises one of a CD player and a DVD player.

7. The compressed digital signal converter of claim 6, further comprising a power amplifier and speakers.

8. The compressed digital signal converter of claim 1, wherein the compressed digital signal files comprise one of MP3, MPEG-4, H.264, WMA (Windows Media Audio), Vorbis (Ogg Vorbis) and WMV (Windows Media Video) files.

10. A compressed digital signal converter, comprising:
a device that converts an analog or digital source signal to a compressed digital signal; and
memory for storing said compressed digital signal.

11. The compressed digital signal converter of claim 10, further comprising a power amplifier and speakers.

12. The compressed digital signal converter of claim 10, wherein the compressed digital signal converter connects mechanically and electrically to an external compressed digital signal storage and playback device.

13. The compressed digital signal converter of claim 10, wherein the compressed digital signal converter is integral with an uncompressed signal storage and playback device.

14. The compressed digital signal converter of claim 10, wherein the uncompressed signal storage and playback device comprises one of a CD player and a DVD player.

15. The compressed digital signal converter of claim 10, wherein the compressed digital signal files comprise one of MP3, MPEG-4, H.264, WMA (Windows Media Audio), Vorbis (Ogg Vorbis) and WMV (Windows Media Video) files.
